(19) United States
(12) Patent Application Publication
(10) Pub. No.: US 2009/0150221 A1
(43) Pub. Date: Jun. 11, 2009

(54) LEAD GENERATION WEB-SITE

(76) Inventor: Karen Marie Downs, Norfolk, VA (US)

Correspondence Address: MICHAEL RIES, 318 PARKER PLACE, OSWEGO, IL, 60543, US

(21) Appl. No.: 12/329,542

(22) Filed: Dec. 6, 2008

Related U.S. Application Data
(60) Provisional application No. 61/012,359, filed on Dec. 7, 2007.

(51) Int. Cl. G06Q 30/00; G06Q 50/00

(52) U.S. Cl. 705/10

(57) ABSTRACT

Disclosed is a lead generation web-site primarily serving the niche market of real estate investors.

This application claims priority to U.S. Provisional Application 61012359, filed Dec. 7, 2007, the entire disclosure of which is incorporated by reference.

### TECHNICAL FIELD AND BACKGROUND

The present invention relates to a lead generation web-site. More specifically, the present invention is a lead generation web-site primarily serving the niche market of real estate investors.

The present invention provides for free advertising of investor deals, affordable lead purchasing for pre-screened leads, and very nominal advertising fees via banner advertising for real estate related services. Sellers post their below-market deals on the site. Buyers can search for deals based on their criteria, and then pay an affordable lead fee for opportunities. The primary website is FixandFlipFanatics.com and it will serve sellers and buyers of a wide variety of real estate investments, but most especially, contract assignments, wholesale deals, mortgage notes, etc. FixMyMortgageMess.com is a feeder website attached to FFF.com to bring in leads from currently distressed mortgage holders.

Real Estate marketing is geared to the retail marketplace where few actual bargains are found. The only known sites where investors can buy leads on deals require paying hefty monthly licensing fees, or substantial monthly subscription rates, but give little or no control over where the deals are, or how good the deal may be. The present invention site focuses on information gathering to provide information about the deal that can be pre-screened by the buyer. The buyer can pick and choose the leads they want and purchase just the amount they desire. No wasted leads or fees. The buyer will also know if deals, such as a pending foreclosure, is time sensitive. There is no buying leads for deals they don't have the time or resources to handle. This site can also be used for service providers who work in the real estate investment market to market their services by way of web-links. It will be the one stop resource for the investor.

The present invention is primarily made of a classified style database with multiple-search criteria access and e-commerce strategies. Search criteria are specific to real investors, but could be used by retail market if looking for a deal.

### BRIEF DESCRIPTION OF THE DRAWINGS

The objects, features, and advantages of the present invention will be apparent from the following detailed description of the preferred embodiment of the invention with references to the following drawings.

FIG. 1 is a flow chart of a lead generation web-site as in one embodiment in accordance with the present invention.

FIG. 2 is a flow chart of a lead generation web-site as in one embodiment in accordance with the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

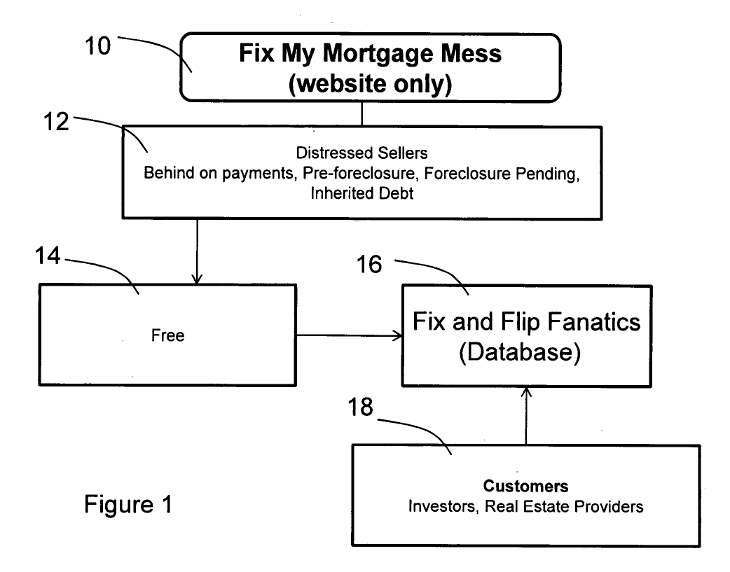

Referring to FIG. 1, as in one embodiment, is a flow chart of a lead generation web-site. Shown is a distressed seller 12 that may be behind on payments, pre-foreclosure, foreclosure pending or inherited debt. The distressed seller 12 will have free 16 access to a Fix and Flip Fanatics database 16. Shown are customers, investors or real estate providers 18 that have access to Fix and Flip Fanatics database 16.

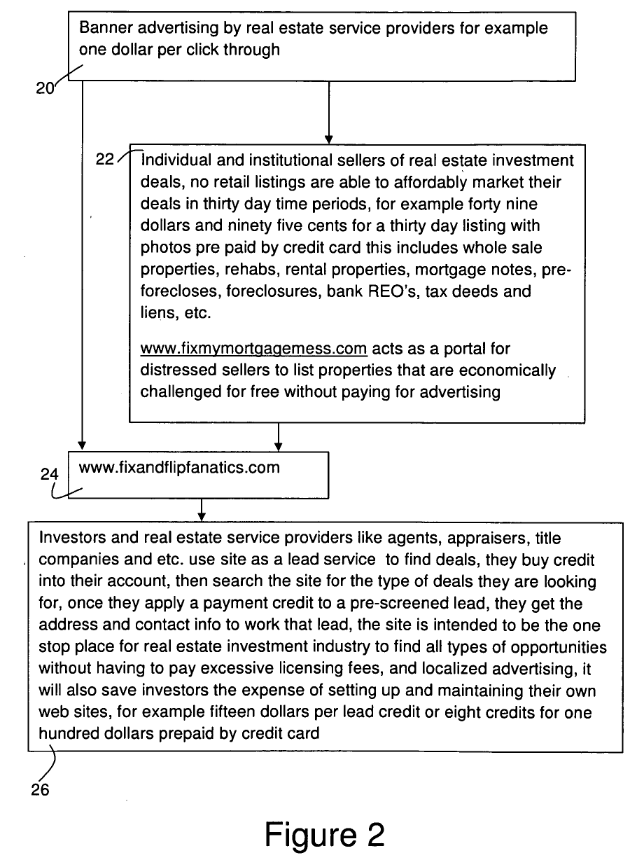

In FIG. 2, as in one embodiment, is a banner advertising by real estate service providers for example one dollar per click through 20 that connects to Individual and institutional sellers of real estate investment deals. No retail listings are able to affordably market their deals in thirty day time periods, for example thirty dollars and for a thirty day listing with photos pre paid by credit card. This includes wholesale properties, rehabs, rental properties, mortgage notes, pre-forecloses, foreclosures, bank REO's, tax deeds and liens, etc.

www.fixmymortgagemess.com acts as a portal for distressed sellers to list properties that are economically challenged without paying for advertising 22. www.fixandflipfanatics.com 24 may come directly after banner advertising by real estate service providers for example one dollar per click through 20. www.fixandflipfanatics.com 24 may come after Individual and institutional sellers of real estate investment deals, no retail listings are able to affordably market their deals in thirty day time periods, for example thirty dollars and ninety five cents for a thirty day listing with photos pre paid by credit card this includes whole sale properties, rehabs, rental properties, mortgage notes, pre-forecloses, foreclosures, bank REO's, tax deeds and liens, etc.

www.fixmymortgagemess.com acts as a portal for distressed sellers to list properties that are economically challenged without paying for advertising 22. After www.fixandflipfanatics.com 24 is Investors and real estate service providers like agents, appraisers, title companies and etc. use site as a lead service to find deals, they buy credit into their account, then search the site for the type of deals they are looking for, once they apply a payment credit to a pre-screened lead, they get the address and contact info to work that lead, the site is intended to be the one stop place for real estate investment industry to find all types of opportunities without having to pay excessive licensing fees, and localized advertising, it will also save investors the expense of setting up and maintaining their own web sites, for example fifteen dollars per lead credit or eight credits for one hundred dollars prepaid by credit card 26.

While the present invention has been related in terms of the foregoing embodiments, those skilled in the art will recognize that the invention is not limited only to the embodiments described. The present invention can be practiced with modification and alteration within the spirit and scope of the appended claims. Thus, the description is to be regarded as illustrative instead of restrictive on the present invention.

What is claimed is:

1. A method to generate leads comprising:
finding a distressed seller that is distressed by a selected one of behind on payments, pre-foreclosure, foreclosure pending and inherited debt;
granting the distressed seller free access to a Fix and Flip Fanatics database; and
providing access to a selected niche of customers, investors and real estate service providers to the Fix and Flip Fanatics database.
